(19) United States
(12) Patent Application Publication
(10) Pub. No.: US 2015/0017846 A1
(43) Pub. Date: Jan. 15, 2015

(54) Fork Type Electrical Connector

(71) Applicant: TRW Limited, Solihull West Midlands (GB)

(72) Inventors: Timothy Bryan Greenway, Warwickshire (GB); David Jonathon Coles, West Midlands (GB)

(73) Assignee: TRW Limited, Solihull West Midlands (GB)

(21) Appl. No.: 14/386,448

(22) PCT Filed: Mar. 8, 2013
(86) PCT No.: PCT/GB2013/050587

§ 371 Date: Sep. 19, 2014

(30) Foreign Application Priority Data
Mar. 20, 2012 (GB) 1204866.6

(51) Int. Cl. H01R 13/04

(52) U.S. Cl. CPC H01R 13/04
USPC 439/891

(57) ABSTRACT

A fork type electrical connector for use in providing an electrical joint comprises a first connector part having a body that supports two spaced prongs; a second connector part comprising a conductive element with a first face and a second opposing face and which is shaped so as to define a rail flanked on opposing sides by respective spaces and a pair of outer legs which extends on opposite sides of the element containing the first face from a respective outer edge of a respective space. In a position of use the prongs extend through respective spaces in the element with the inner edges engaging the edges of the rail to provide an electrically conductive connection and the outer edge of the prongs engaging the legs to apply a force to the prongs that resists the reaction force generated between the prong and the rail.

This invention relates to an electrical connector for use in providing a permanent electrical joint between two parts of an electrical circuit, and in particular to a type of permanent or semi-permanent joint that may be formed using a connector known as “fork connector”, the joint comprising a first part having a pair of prongs shaped like a tuning fork and a second part having an elongate conductive rail that is straddled by the prongs of the first part such that during assembly the two parts are physically forced to create and interference fit between the parts.

By permanent or semi-permanent joint we mean that the connection is not intended to be separated during the life of the joint, although of course it will be understood that like most things which are made up of multiple parts it could be separated if required by application of sufficient physical force.

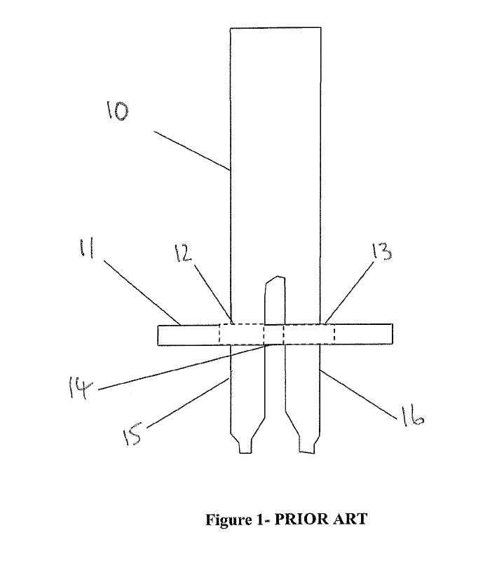

A known fork type connector is shown in FIG. 1. As can be seen, a conductive rail 14 of a second part 11 which engages with an interference or force fit between two prongs 15,16 of a first connector part 10. The rail 14 is formed by cutting or stamping two spaced apart rectangular spaces 12,13 in a flat conductive strip or plate of material supported in an insulated housing (not shown). The edges of the spaces defining the side of the rail 14 are square cut and as such the rail 14, which is the remaining part of the plate between the spaces, also has square cut edges. Insertion of the prongs 15,16 into the spaces causes them to straddle the rail 14, and during connection causes the prongs 15,16 and rail 14 to smear across one another resulting in an interference type fit between the two parts. This smearing is significant because it ensures that the top layer of the contact surfaces which may be oxidised or covered in other contaminants, is pushed aside ensuring a reliable connection between the relatively cleaner underlying surfaces of the two parts. Removal of surface contaminants, especially oxides, also reduces the contact resistance, minimising heating of the joint by the current that flows across it. This helps the joint withstand changes in temperature in without degradation.

According to a first aspect the invention provides a fork type electrical connector for use in providing an electrical joint between two parts of an electrical circuit comprising:

a first connector part having a body that supports two spaced prongs that are electrically conductive;

a second connector part comprising a conductive element with a first face and a second opposing face and which is shaped so as to define an electrically conductive rail which is flanked on opposing sides by respective spaces, the width of each space measured from an inner edge of the space defined by the rail to an opposing, outer edge, of the space being less than the width of at least one of the prongs of the first connector part to ensure an interference fit of the prong when located in the space;

and characterised in that a pair of outer legs are provided, each of which extends on a side of the element containing the first face from a respective outer edge of a respective space;

and whereby in a position of use with the first and second connectors connected the prongs extend through respective spaces in the element with the inner edges of the prongs engaging the edges of the rail to provide an electrically conductive connection and the outer edge of the prongs engaging the legs, such that the legs apply a force to the prongs that resists the reaction force generated between the prong and the rail.

The prongs may be of the same material as the rail, preferably a low yield strength material such as a “soft” metal like copper or an alloy of copper. The provision of the outer legs to resist the contact forces makes such a material suitable for use in this joint for application where it may not have been suitable when the joint was constructed according to the prior art.

The prongs may perhaps be plated with a conductive coating.

In one arrangement the first connector part forming the prongs may be formed as a laminate of different layers of material, using one or many different materials.

The outer legs may extend along the full length of the edge of the opening, having the same length as the rail.

The outer legs may be electrically conductive, so that the contact with the prong provides an additional electrical contact and path across the joint.

The legs may be linked to the edge of the space through a curved linking section which encourages smearing of the material of the prongs or legs as the connection is made.

In addition to the two outer legs, the second connector part may include a pair of inner legs which extend away from the first face and are connected to the edges of the conductive rail.

In a position of use with the connector connected, the prongs may form an interference fit with the face of the inner legs of the rail, or with the outer legs, or with both the inner and outer legs. This interference fit helps expose a clean surface free of surface contaminants and oxidation which forms the electrical contact across which current flows through the joint.

The rail and inner legs may together define a rail with a U shape in cross section.

The first connector part may comprise in addition at least a portion which comprises a material that has a different coefficient of expansion to the conductive prongs and arranged such that as the temperature of the connector part increases at least a portion of the inside edges of the prongs are pushed closer together. The first connector part therefore deforms in the manner of a bi-metallic strip, and this helps ensure the connection is maintained with a good force as temperature increases.

A second function of the overmolding is that it may help address a problem that the applicant has indentified in the prior art joints caused by the material creeping over time. The applicant has noted that a conductive material such as copper can creep over time, relaxing its grip on the rail at high temperatures. This can be ameliorated by the use of the portion with a different coefficient of expansion, and which is expected to remain elastic within the temperature environment which the part is exposed to. It should be chosen so that it has a heat deflection temperature above the maximum storage or operating temperature of the joint, for instance 100 degrees centrigrade or perhaps 150 degrees centigrade.

At least a part of the body and a part of the prongs of the first part may be surrounded by a close fitting sleeve which has a higher coefficient of expansion than the body and prongs, the body and prongs and the sleeve being so constructed and arranged that heating of the first connector part causes at least part of the inner edges of the prongs to tend to move together slightly.

The applicant has appreciated that the stability of the overmolding at elevated temperatures may help to mitigate the effects of creep in the prong and rail material. This can be used to provide a more reliable joint, or may advantageously be used to enable a wider range of materials to be employed for any given joint.

The conductive prongs may be keyed to the sleeve using one or more interlocking features to prevent relative movement.

The close fitting sleeve may comprise an overmolding of the body and prongs. It may comprise a reinforced plastic material or similar.

In use the overmolding urges the prongs together which helps maintain the clamping force of the prongs onto the conductive rail.

The outer edge of each prong, or of any overmolding that is provided, may be provided with a crush structure, that may extend along all or a part of a length of the prong, of increasing cross section towards its root, such as a v-shaped or u-shaped ridge, with the peak of the v or U facing away from the prong, whereby when connected the crush feature of a prong presses against a respective outer leg of the second connector part. The crush structure may be adapted to collapse in a controlled manner as the prongs are inserted the force required to achieve a given amount of collapse increasing the more that the structure has collapsed due to its increasing cross section.

The crush feature may comprise a molded plastic material.

The provision of a crush feature helps ensure a consistent force within the connector which helps ensure a good electrical connection regardless variations in the width of the spaces and width of the prongs that may arise during manufacture due to tolerances.

The first connector part may comprise a part of an electrical lead frame. The second connector part may also comprise a part of a lead frame. One of the lead frames may be an integral part of an electric pump or electric motor or other electrical device.

In at least arrangement, the first connector part may comprise multiple pairs of prongs, each pair straddling a rail of the second part with an interference fit. At least one of the prongs may be urged into contact with the rail by a pair of outer legs of the second part, and preferably all of the prongs may be urged into contact by outer legs.

In use, the first part is connected to one part of an electrical circuit, and the second part is connected to another, the connector providing a joint through which current can flow between the two parts of the electrical circuit.

According to a second aspect the invention provides a first connector part which may be pressed into engagement with a second connector part to provide a permanent electrical joint according to the first aspect of the invention.

According to a third aspect the invention provides a second connector part which may be pressed into engagement with a first connector part to provide a permanent electrical joint according to the first aspect of the invention.

There will now be described by way of example only several embodiments of the present invention with reference to and as illustrated in the accompanying drawings of which:

FIG. 1 is a representation of a prior art electrical joint;

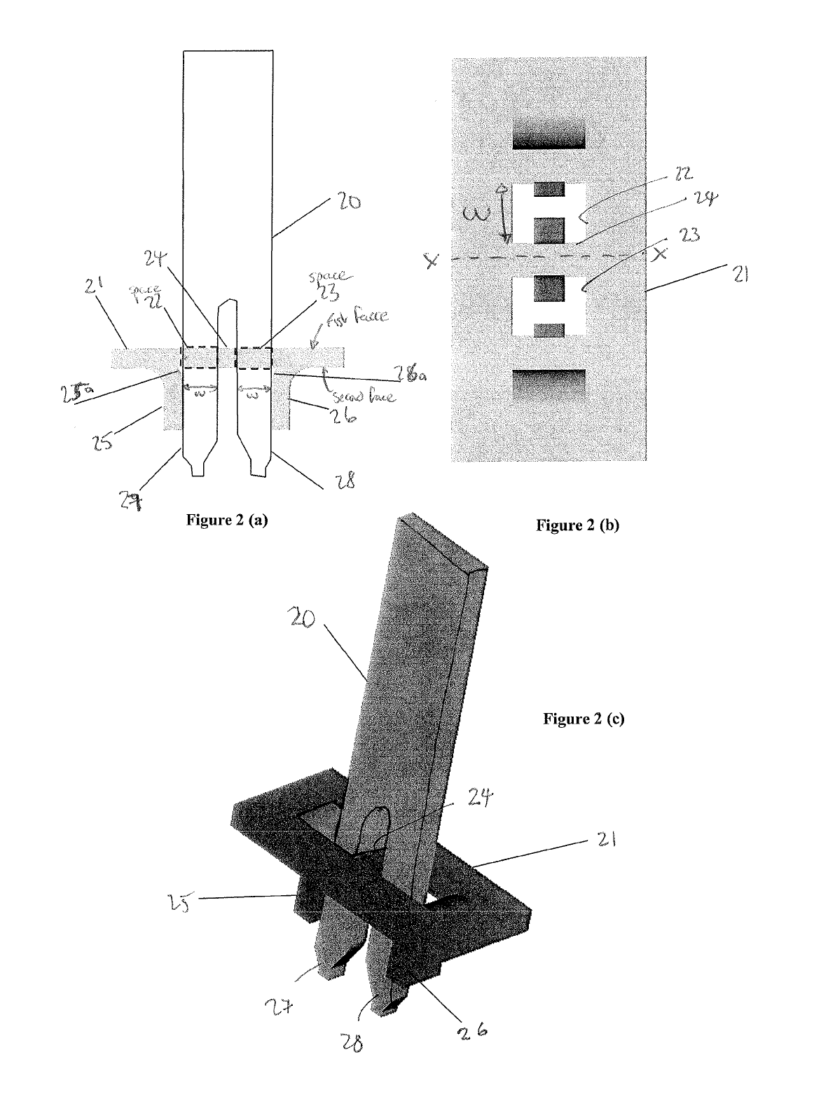

FIG. 2(a) is a view in section 2(b) is a view from above and 2(c) is an isometric view of a first embodiment of a connector assembly in accordance with the present invention;

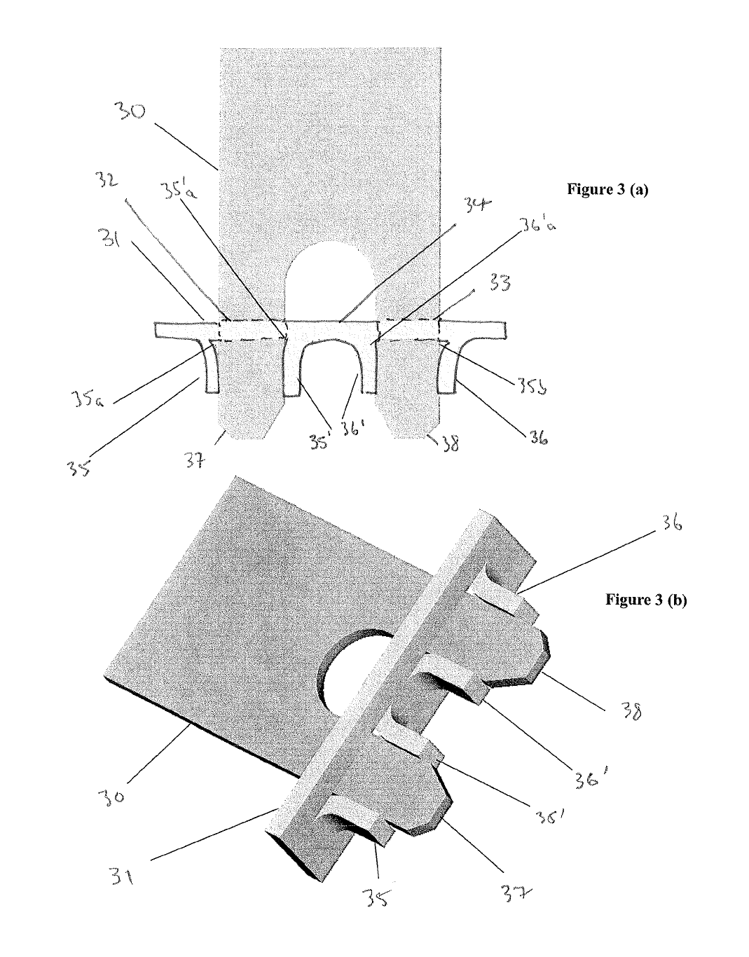

FIG. 3(a) is a view in section and 3(b) is an isometric view of a second embodiment of a connector assembly according to the present invention;

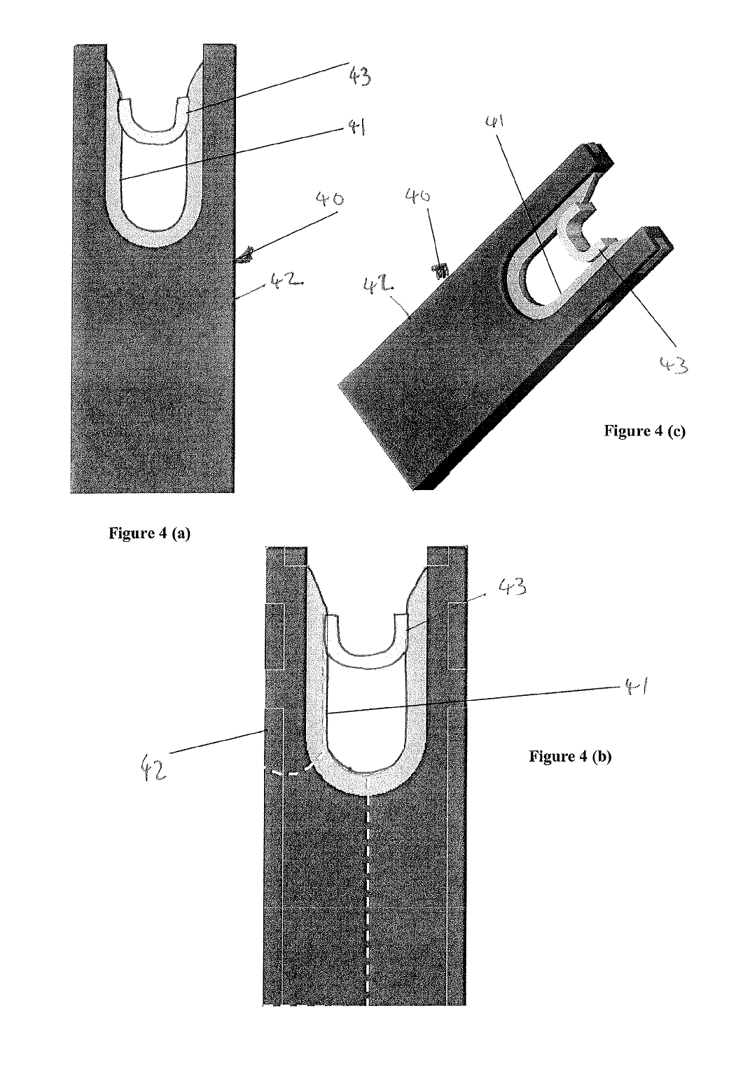

FIG. 4(a) is section view, 4(c) is an isometric view and 4(b a cross section view of a first connector part and a portion of a second connector part of a third embodiment of a connector assembly according to the present invention; and

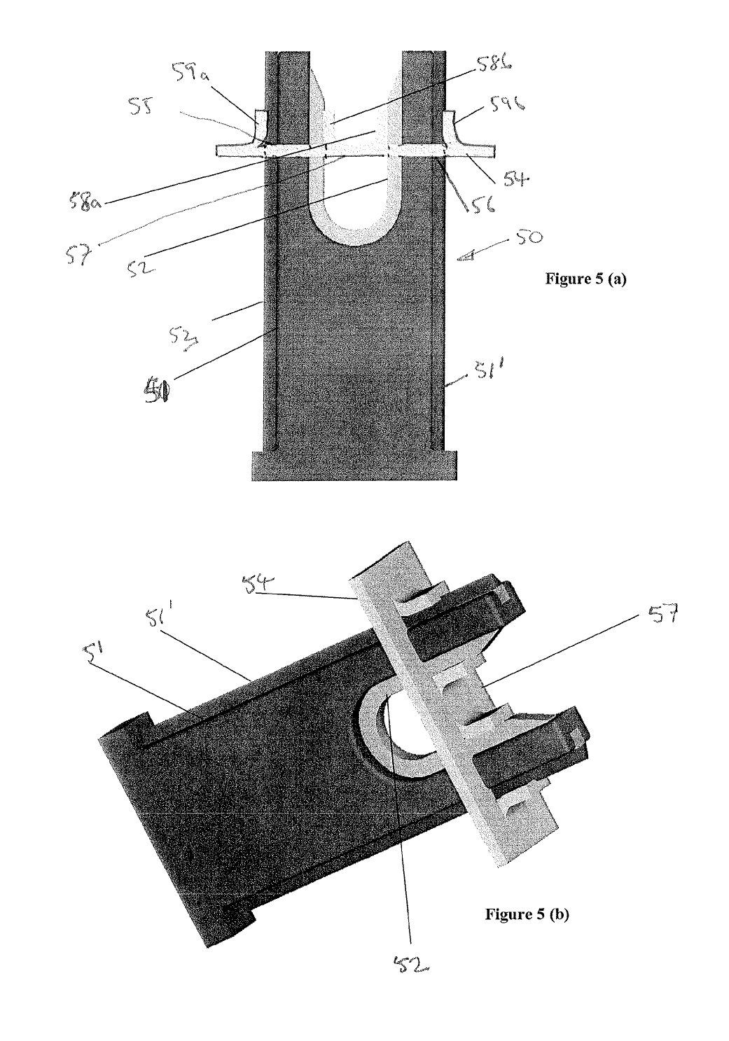

FIG. 5(a) is a cross section view and (b) a perspective view of a fourth embodiment of an electrical connector according to the present invention;

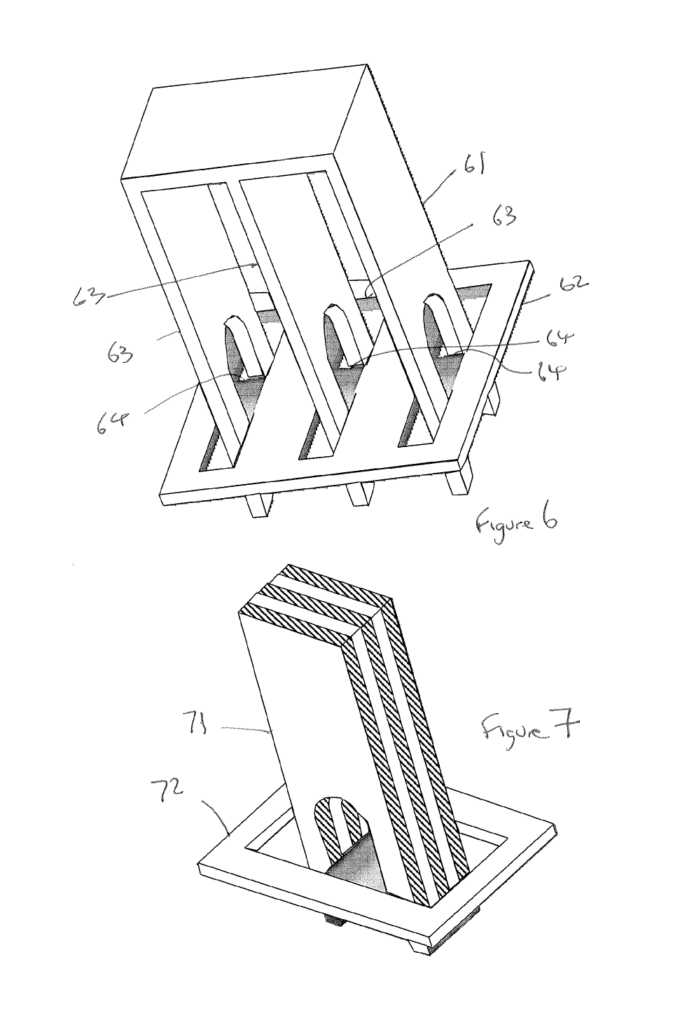

FIG. 6 is an isometric view of a still further electrical connector within the scope of the present invention; and

FIG. 7 is an isometric view of another electrical connector within the scope of the present invention.

As shown in FIGS. 2(a) to (c) a first embodiment of a tuning fork type connector assembly comprises a first connector part 20 and a second connector part 21. The first part 20 and the second part 21 can engage one another as shown in the figures to form an electrical connection where current can flow from one part to the other.

The first connector part 20 comprises a body and two prongs 27,28 which extend from the body. The prongs 27,28 are identical in this example, being a mirror image of each other and located on either side of a plane which passes through a middle line of the body. The body and prongs are electrically conductive, typically a low yield strength metal which exhibits a degree of creep over time, perhaps copper or an alloy predominantly of copper. The body and prongs in this example all lie in a common plane and may be made, for example, by stamping or pressing or otherwise forming from a sheet.

The second connector part 21 comprises a conductive rail 24. The rail 24 is part of a strip or plate of low yield strength material, such as copper or an alloy predominantly of copper. The strip has a first face and an opposing second face and two spaces or through holes 22, 23, formed within it which extend from the first face through to the second face which are located side by side. The spaces are marked by dashed lines in FIG. 2(a). Where the second part comprises a strip the spaces may be arranged in series along the long axis of the strip, the part of the strip between the spaces defining the elongate conductive rail 24. The rail has a width that is very slightly greater than the spacing between the prongs of the first connector part 20 prior to connection to the second connector part. As shown in FIG. 2(b) the width of each space W, measured perpendicular to the long axis of the rail X-X strip is slightly smaller than the width w of a prong.

Connected to the edge of each space furthest from the rail 24 is a respective outer leg 25,26 which extends generally orthogonally away from the face of the strip, i.e at right angles to the plane containing the strip. The two outer legs 25,26 extend from the same face of the strip and are electrically conductive. Indeed they are an integral part of the strip. The regions 25a, 26a where the legs 25,26 join the face of the strip is curved so that there is a smooth transition from a face of the strip that is on the opposite side to the legs along on to a face of the legs. As will become apparent this helps achieve smearing of the surface material when the electrical connector is assembled into a permanent joint. The radius of this curve is not critical, and for this example is around 5 to 10 percent of the width of each space. Because of this curve, the outer legs may be considered to extend slightly into the space directly below the space, assuming the strip is held with the legs extending down and the edge of the space being the region where the strip transitions into the curve. In fact, the width of the spaces and location of the legs are such that the prongs of the first connector part 20 cannot pass through the spaces without deformation of the first connector part or second connector part.

In use, the first connector part 20 is aligned with the second connector part 21 with the prongs 27,28 facing the spaces 22,23 and on the opposite side of the conductive rail 24 of the second connector part to the legs 25,26. The prongs 27,28 are then pressed through the respective spaces 22,23, which causes the inner edges of the prongs- those edges that face one another- to cut and or smear the edges of the conductive rail 24. This connecting action causes some smearing of the outer edges of the prongs and the outer legs, splaying the legs outwards slightly away from each other. The legs oppose this, applying an inward force to the prongs to push them onto the conductive rail.

With the first and second connector parts 20, 21 fully engaged ,there is a good contact between the two parts which provides a good electrical connection. The legs help press the prongs onto the conductive rail and provide additional contact surface contact force to help resist creep.

A second embodiment is shown in FIGS. 3(a) to (c) of the drawings. This is generally the same as the first embodiment with many common features.

The first connector part 30 is identical to that of the first embodiment and comprises a body and two prongs 37,38 which extend from the body. The prongs in this example are slightly wider spaced than those of the first to accommodate a relatively wider rail as will be described.

The second connector part 31 is similar to that of the first embodiment and comprises a flat strip or plate with two spaces 32,33 which are separated by a conductive rail 34. Connected to the edge of each space furthest from the rail is a respective outer leg 35,36 which extends generally orthogonally away from the strip. The regions 35a,35b where each of the legs joins the strip is curved so that there is a smooth transition from a face of the strip that is on the opposite side to the legs along on to a face of the legs.

The second embodiment differs from the first embodiment in that two further, inner, legs 35′, 36′ are provided, each one extending away from a respective edge of the conductive rail 34 that defines an edge of a respective space. These legs 35′,36′ extend along the full length of the conductive rail 34, such that the rail can be considered to have a shape such as a U shape when viewed in cross section. The inner pair of legs are connected by a smooth curved portion to the rail, and are electrically conductive like the outer pair of legs. All four legs are on the same side of the strip or plate.

In use, the first connector part 30 is secured to the second connector part 31 by pressing the prongs 37,38 through the spaces so that they straddle the U shaped rail 34. The prongs cut into the surfaces of the inner and outer legs, splaying the outer legs away from one another and pressing the inner legs towards each other. This provides a good contact between the prongs and the conductive legs. The curved edges to the legs also promotes smearing of the material at the join in addition to a cutting action. The U shaped rail is more physically robust than the prior art design which uses a thin flat rail, and this facilitates higher insertion forces, contact pressue and consequently lower electrical contact resistance.

A third embodiment of the invention is shown in FIGS. 4 (a) to (c) of the drawings.

In this embodiment, the first connector part 40 again comprises a body and prongs 41 of conductive copper or copper alloy material. The body and prongs are overmolded with a reinforced plastic material 42, such as glass filled PBT or similar, part of the overmolding being cut-away around the inner edges of the prongs to expose the conductive material. The second connector portion comprises an elongate rail 43 of U-shaped cross section, although it may have the same section as the rail shown in FIGS. 1 and 2, that fits between the prongs. The degree to which the overmolding is cut away may partly be to recognise tooling considerations, and the inner edges are the only bits that need to be exposed.

In use, the prongs straddle the u-shaped rail 43 to give a good electrical contact between the rail and the prongs. An advantage of this embodiment over one which does not have an overmolding comes to light when the temperature of the connection increases. By choosing an overmolding material that has a higher coefficient of expansion that the copper or copper alloy, and making it sufficiently rigid relative to the prongs, the edges of the prongs that contact the rail 43 can be urged towards the rail as the temperature increases, thus increasing the security of the electrical connection by restraining outward expansion of the prongs. The applicant has noted that the stability of the overmolding at elevated temperatures may help mitigate the effects of creep in the material of the prongs and or rail.

A fourth embodiment is shown in FIGS. 5(a) and (b). This combines features from the second and third embodiments.

The first connector part 50 comprises a conductive copper or copper alloy body and prongs 52, and is overmolded with a rigid plastic reinforced material 51. Along the outer edges of each prong is a raised ridge 51′ of relatively rigid plastic having crush feature of increasing cross section towards its root, such as a v-shaped cross section, the peak of the v facing away from the prongs. The overmolding is shaped so that the copper or copper alloy material is exposed along an inner edge of each prong.

A second portion 54 is provided which is similar to that of the second embodiment, with two spaces 55,56 having a u-shaped rail 57 with inner legs 58a and 58b and outer legs 59a, 59b. The spacing between the legs prior to connecting to the first part is less than the width of a prong plus the overmolding including the V-shaped ridge.

During connection, the prongs are pushed into the spaces 55,56, and the inner edges of the prongs cuts into the sides of the u-shaped rails. Some smearing of the material occurs due to the curved interface of the inner legs and upper face of the rail. The v-shaped ridges press against and deform the outer legs and acts as a crush feature to control the force applied by the inner edges of the prongs on the u-shaped rail 57. This helps ensure contact pressure despite variations in the size of the spaces, and width of the prongs that may occur due to manufacturing tolerances.

In use, any increase in temperature will see the metal prongs moving inwards slightly towards each other to press further against the u-shaped rail 57 as they are constrained by the plastic overmolding, This increases the security of the connection. The v-shaped ridges on the outer edges of the prongs function as crush structures, collapsing as the prongs are inserted. This helps control the forces exerted by the inner edges of the prongs onto the u-shaped rail.

Various modifications can be made within the scope of the present invention. FIG. 6 illustrates how a connector can be provided which has a first connector part 61 and a second part 62 including a rail, the first part including multiple prongs 63 connected in series to respective rails 64. This arrangement provides multiple pathways for current to flow across the completed joint, giving an increased number of regions of contact and hence reducing the flux and potential for self heating of the joint.

In a still further alternative a first connector part 71 and a second connector part 72 may be provided in which the prong may be formed as a laminate of several sheets of material, perhaps with differing physical properties.

The multiple prongs/rails and laminated prongs can of course be incorporated into the embodiments shown in FIGS. 2 to 5 if desired.

1. A fork type electrical connector for use in providing an electrical joint between two parts of an electrical circuit comprising:
a first connector part having a body that supports two spaced prongs that are electrically conductive;
a second connector part including a conductive element with a first face and a second opposing face and which is shaped so as to define an electrically conductive rail which is flanked on opposing sides by respective spaces, a width of each space measured from an inner edge of the space defined by the rail to an opposing, outer edge, of the space being less than a width of at least one of the prongs of the first connector part to ensure an interference fit of the prong when located in the space;
and characterized in that a pair of outer legs are provided, each of which extends on a side of the conductive element containing the first face from a respective outer edge of a respective space;
and whereby in a position of use with the first and second connectors connected, the prongs extend through respective spaces in the element with the inner edges of the prongs engaging the edges of the rail to provide an electrically conductive connection and the outer edge of the prongs engaging the legs, such that the legs apply a force to the prongs that resists the reaction force generated between the prong and the rail.

2. A fork type electrical connector according to claim 1 in which the prongs are the same material as the rail.

3. A fork type electrical connector according to claim 1 in which the prongs are plated with a conductive coating.

4. A fork type electrical connector according to claim 1 in which the first connector part forming the prongs is formed as a laminate of different layers of material, using one or many different materials.

5. A fork type electrical connector according to claim 1 in which the outer legs extend along the full length of the edge of the opening, having the same length as the rail.

6. A fork type electrical connector according to claim 1 in which the outer legs are electrically conductive, so that the contact with the prong provides an additional electrical contact and path across the joint.

7. A fork type electrical connector according to claim 1 in which the legs are linked to the edge of the space through a curved linking section which encourages smearing of the material of the prongs or legs as the connection is made.

8. A fork type electrical connector according to claim 1 in which the second connector part includes a pair of inner legs which extend away from the first face and are connected to the edges of the conductive rail.

9. A fork type electrical connector according to claim 8 in which, in a position of use with the connector connected, the prongs form an interference fit with the face of the inner legs of the rail, or with the outer legs, or with both the inner and outer legs.

10. A fork type electrical connector according to claim 8 in which the rail and inner legs together define a rail that is generally U-shaped in cross section.

11. A fork type electrical connector according to claim 1 in which the first connector part includes in addition at least a portion which includes a material that has a different coefficient of expansion to the conductive prongs and arranged such that as the temperature of the connector part increases, at least a portion of the inside edges of the prongs are pushed closer together.

12. A fork type electrical connector according to claim 1 in which at least a part of the body and a part of the prongs of the first part are surrounded by a close fitting sleeve which has a higher coefficient of expansion than the body and prongs, the body and prongs and the sleeve being so constructed and arranged that heating of the first connector part causes at least part of the inner edges of the prongs to tend to move together slightly.

13. A fork type electrical connector according to claim 12 in which the conductive prongs are keyed to the sleeve using one or more interlocking features to prevent relative movement.

14. A fork type electrical connector according to claim 12 in which the close fitting sleeve includes an overmolding of the body and prongs.

15. A fork type electrical connector according to claim 1 in which the outer edge of each prong is provided with a crush structure that extends along all or a part of a length of the prong, of increasing cross section towards its root, whereby when connected the crush structure of a prong presses against a respective outer leg of the second connector part.

16. A fork type electrical connector according to claim 1 in which the first connector part includes a part of an electrical lead frame.

17. A fork type electrical connector according to claim 1 in which the first connector part includes multiple pairs of prongs, each pair straddling a rail of the second part with an interference feet.

18. A first connector part which may be pressed into engagement with a second connector part to provide a permanent electrical joint according to claim 1.

19. A second connector part which may be pressed into engagement with a first connector part to provide a permanent electrical joint according to claim 1.
